(19) United States
(12) Patent Application Publication
(10) Pub. No.: US 2026/0162591 A1
(43) Pub. Date: Jun. 11, 2026

(54) DISPLAY DEVICE AND DRIVING METHOD THEREOF

(71) Applicant: Hefei Visionox Technology Co., Ltd., Hefei (CN)

(72) Inventors: Chuanshen LUO, Hefei (CN); Shaojie ZHU, Hefei (CN); Weiwei PAN, Hefei (CN); Yafei ZHANG, Hefei (CN); Xinquan CHEN, Hefei (CN); Wenquan CHU, Hefei (CN)

(73) Assignee: Hefei Visionox Technology Co., Ltd., Hefei (CN)

(21) Appl. No.: 19/180,079

(22) Filed: Apr. 15, 2025

Related U.S. Application Data
(63) Continuation of application No. PCT/CN2023/135296, filed on Nov. 30, 2023.

(30) Foreign Application Priority Data
Jun. 28, 2023 (CN) 202310781110.5

(51) Int. Cl. G09G 3/32

(52) U.S. Cl. CPC G09G 3/32; G09G 2300/0819; G09G 2310/0286; G09G 2310/08; G09G 2320/0233; G09G 2340/0435

(57) ABSTRACT

Provided are a display device and a driving method thereof. The display device includes a plurality of pixel circuits arranged in an array, a first scanning circuit, a plurality of first scanning lines and a first voltage line. The first voltage line is electrically connected to the plurality of pixel circuits, where each pixel circuit of the plurality of pixel circuits is configured to write a voltage on the first voltage line to the each pixel circuit in response to a pulse signal of a first scanning signal on a first scanning line. Different voltages are output to the first voltage line in a first period and a second period in at least one image refresh period.

### CROSS-REFERENCE TO RELATED APPLICATION

This is a continuation of International Patent Application No. PCT/CN2023/135296, filed on Nov. 30, 2023, which is based on and claims priority to a Chinese Patent Application No. CN 202310781110.5 filed on Jun. 28, 2023, disclosures of which are incorporated herein by reference in their entireties.

### FIELD

The present application relates to the field of display technology, for example, a display device and a driving method thereof.

### BACKGROUND

With the development of display technology, people's increasingly high requirements are imposed on the display quality of display panels.

A conventional display panel has a phenomenon of non-uniform display brightness, resulting in a visual effect of non-uniform display and severely reduced display quality.

### SUMMARY

The present application provides a display device and a driving method thereof to improve a phenomenon of non-uniform display of the display device in a display process, to improve display quality.

The present application provides a display device. The display device includes a plurality of pixel circuits, a first scanning circuit, a plurality of first scanning lines and a first voltage line.

The plurality of pixel circuits are arranged in an array.

The first scanning circuit is electrically connected to the plurality of pixel circuits by plurality of first scanning lines.

The first voltage line is electrically connected to the plurality of pixel circuits, where each pixel circuit of the plurality of pixel circuits is configured to write a voltage on the first voltage line to the each pixel circuit in response to a pulse signal of a first scanning signal on a first scanning line.

Different voltages are output to the first voltage line in a first period and a second period in at least one image refresh period.

The present application further provides a driving method of a display device. The driving method of a display device includes the steps described below.

In a first period, a voltage is output to a first voltage line, a corresponding row of pixel circuits write the voltage on the first voltage line to the corresponding row of pixel circuits in response to a pulse signal of a first scanning signal on at least one first scanning line of a plurality of first scanning lines. The display device includes the plurality of pixel circuits arranged in an array, a first scanning circuit, the plurality of first scanning lines and the first voltage line. The first scanning circuit is electrically connected to a corresponding row of pixel circuits by a corresponding first scanning line, and the first voltage line is electrically connected to the plurality of pixel circuits.

In a second period, a voltage different from that in the first period is output to the first voltage line, a corresponding row of pixel circuits of the plurality of pixel circuits write the voltage on the first voltage line to the corresponding row of pixel circuits in response to a pulse signal of a first scanning signal on at least one first scanning line of the plurality of first scanning lines.

In the embodiment of the present application, the different voltages are output to the first voltage line in the first period and the second period in the at least one image refresh period, and each pixel circuit of the plurality of pixel circuits writes the voltage on the first voltage line to the each pixel circuit in response to the pulse signal of the first scanning signal on the respective one of the plurality of first scanning lines. Since the first voltage line writes the different voltages to the pixel circuits in the first period and the second period, undesirable phenomena such as non-uniform display caused by an in-plane load difference in the different periods in the display device can be improved, to contribute to improving a display effect.

### BRIEF DESCRIPTION OF DRAWINGS

FIG. 1 is a partial structural diagram of a pixel circuit in the related art.

FIG. 2 is a schematic diagram of a display result of a display panel in the related art at an occasion.

FIG. 3 is a schematic diagram of a display result of the display panel shown in FIG. 2 at another occasion.

FIG. 4 is a structural diagram of a display device according to an embodiment of the present application.

FIG. 5 is a schematic diagram of a waveform of drive timing according to an embodiment of the present application.

FIG. 6 is a schematic diagram of a waveform of a voltage transmitted on a first voltage line according to an embodiment of the present application.

FIG. 7 is a structural diagram of a pixel circuit according to an embodiment of the present application.

FIG. 8 is a structural diagram of another pixel circuit according to an embodiment of the present application.

FIG. 9 is a structural diagram of another pixel circuit according to an embodiment of the present application.

FIG. 10 is a drive timing graph of a pixel circuit according to an embodiment of the present application.

FIG. 11 is a schematic diagram illustrating a voltage variation of a first initialization signal line according to an embodiment of the present application.

FIG. 12 is a drive timing graph of another pixel circuit according to an embodiment of the present application.

FIG. 13 is a schematic diagram illustrating a display result of a display panel according to an embodiment of the present application in a first period.

FIG. 14 is a schematic diagram illustrating a display result of a display panel according to an embodiment of the present application in a second period.

FIG. 15 is a drive timing graph of another pixel circuit according to an embodiment of the present application.

FIG. 16 is a flowchart of a driving method of a display device according to an embodiment of the present application.

### DETAILED DESCRIPTION

Terms such as “first” and “second” in the description, claims, and above drawings of the present application are used to distinguish between similar objects and are not necessarily used to describe a particular order or sequence. It is to be understood that data used in this manner is interchangeable in appropriate cases and the embodiments of the present application described herein can also be implemented in an order not illustrated or described herein. In addition, terms “comprising”, “including”, and any variation thereof are intended to encompass a non-exclusive inclusion. For example, a process, method, system, product, or device that includes a series of steps or units not only includes the expressly listed steps or units, but may also include other steps or units that are not expressly listed or are inherent to such a process, method, product, or device.

A display panel in the related art has a display split-screen phenomenon, resulting in reduced display quality. Through researches, the inventors found that a reason for the occurrence of the above problem is as follows: the display panel has different refresh rates in different operation modes. A low refresh rate is implemented through frame skipping on the basis of a high refresh rate. A display period includes a write frame and a holding frame. The holding frame is inserted behind the write frame, and the duration of the holding frame is adjusted, thereby varying the refresh rate. The display panel generally includes a pixel circuit configured to drive a light-emitting device to emit light. In the case of low-frequency displaying, a first electrode or a second electrode of a drive transistor in the pixel circuit is in a bias state for a long time, resulting in a drift in characteristics of the drive transistor. In this manner, a difference is between the display brightness of the drive transistor in the holding frame and the write frame and a flicker phenomenon occurs. In the related art, to solve the above problem, voltage biasing is generally performed on the first electrode or the second electrode of the drive transistor to improve the threshold characteristics of the drive transistor.

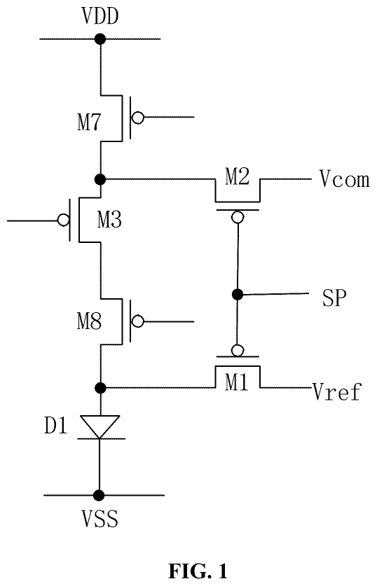

FIG. 1 is a partial structural diagram of a pixel circuit in the related art. Referring to FIG. 1, the pixel circuit includes a first transistor M1, a second transistor M2, a third transistor M3, a seventh transistor M7 and an eighth transistor M8. The third transistor M3 is a drive transistor. At an initialization stage, the first transistor M1 is turned on in response to a scanning signal SP and transmits an initialization voltage Vref to a first electrode of a light-emitting diode D1 to initialize an anode of the light-emitting diode D1. At the same time, the second transistor M2 is turned on in response to the scanning signal SP and transmits a bias voltage Vcom to a first electrode of the third transistor M3 to reset a voltage of the first electrode of the third transistor M3 to vary a bias state of the third transistor M3, to improve threshold characteristics of the third transistor M3 to reduce a brightness difference between a holding frame and a write frame and improve uniformity of display brightness.

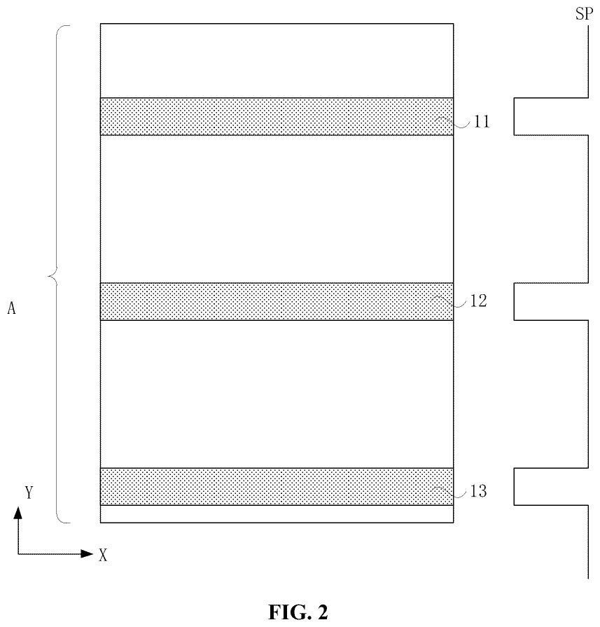

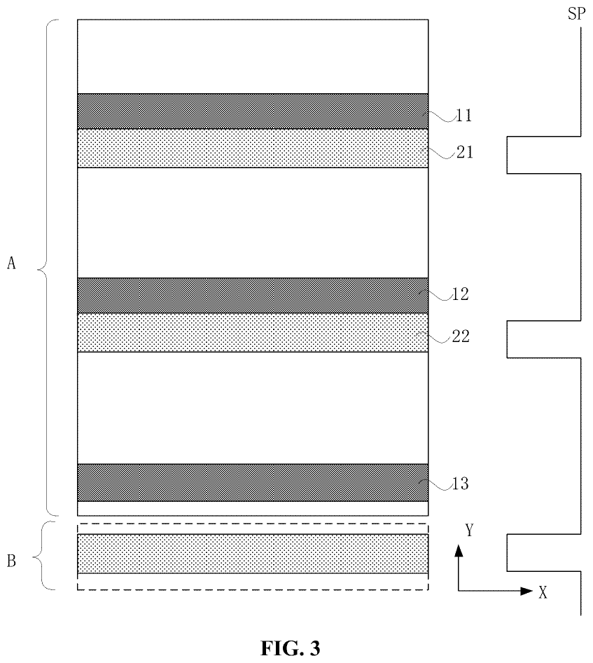

In an actual application process, the scanning signal SP simultaneously controls the initialization of the anode of the light-emitting diode D1 and the voltage biasing of the third transistor M3. The scanning signal SP is a high-frequency signal and includes a plurality of pulse signals. When the scanning signal SP succeeds in scanning a blank stage between adjacent frames (e.g. one frame is one display period is used as an example), a brightness difference is between different display regions of a display panel and a “split-screen” phenomenon occurs. For ease of understanding, a specific example is used for description. FIG. 2 is a schematic diagram of a display result of a display panel in the related art at an occasion. FIG. 3 is a schematic diagram of a display result of the display panel shown in FIG. 2 at another occasion. Referring to FIGS. 1 to 3, a plurality of pixel circuits are disposed in a display region A of the display panel, and the scanning signal SP includes a plurality of pulses in a display period. In an effective level of the scanning signal SP, the first transistor M1 and the second transistor M2 are turned on in response to the pulse signals of the scanning signal, respectively, to initialize the first electrode of the light-emitting diode D1 and the first electrode of the third transistor M3. The scanning signal SP including three pulses is used as an example. A pulse width is associated with the scanning time of a pixel row. Here, a pulse width of the scanning signal SP may correspond to the scanning time of a plurality of rows (for example, 20 rows) of pixel circuits. After the pixel circuit is in a stable operating state, at the same stage of a display period, pixel circuits in three regions in the display region A initialize a first electrode of a light-emitting diode D1 and a first electrode of a third transistor M3, that is, 20 rows of pixel circuits in a first region 11, 20 rows of pixel circuits in a second region 12 and 20 rows of pixel circuits in a third region 13 initialize a light-emitting diode D1 corresponding to each region in response to the three pulses of the scanning signal SP, respectively. In this case, the load in the display region A is the load corresponding to the 60 rows of pixel circuits.

As shown in FIG. 3, with the passage of time, one piece of pulse timing of the scanning signal SP enters the blank stage, which may correspond to a Blank region B. Here, the Blank region B does not really exist on the display panel and is only embodied in a time dimension. That is, when one piece of pulse timing of the scanning signal SP enters the blank stage, only two regions, a fourth region 21 and a fifth region 22, are scanned in the display region A. In this case, the load in the display region A is the load corresponding to 40 rows of pixel circuits and in the display period, pixel circuits in two regions in the display panel are initializing at one stage and pixel circuits in three regions are initializing at another stage. This causes that at different display stages, the number of rows of scanning circuits in corresponding pixel rows and the number of rows of pixel circuits driven by an initialization signal line providing the initialization voltage Vref are different and a difference is in in-plane load. When one piece of pulse timing of the scanning signal SP enters the blank stage, the in-plane load is smaller and an initialization degree of a first electrode of a light-emitting diode D1 corresponding to the pixel circuits in the fourth region 21 and the fifth region 22 is more sufficient. As a result, a voltage difference between the first electrode and a second electrode of the light-emitting diode D1 in the fourth region 21 and the fifth region 22 is different from a voltage difference of the light-emitting diode D1 in another region, and display brightness in the fourth region 21 and the fifth region 22 is different from display brightness in another region. Therefore, the display region A is divided into three portions at positions of the fourth region 21 and the fifth region 22, and an effect of three split screens is visually presented.

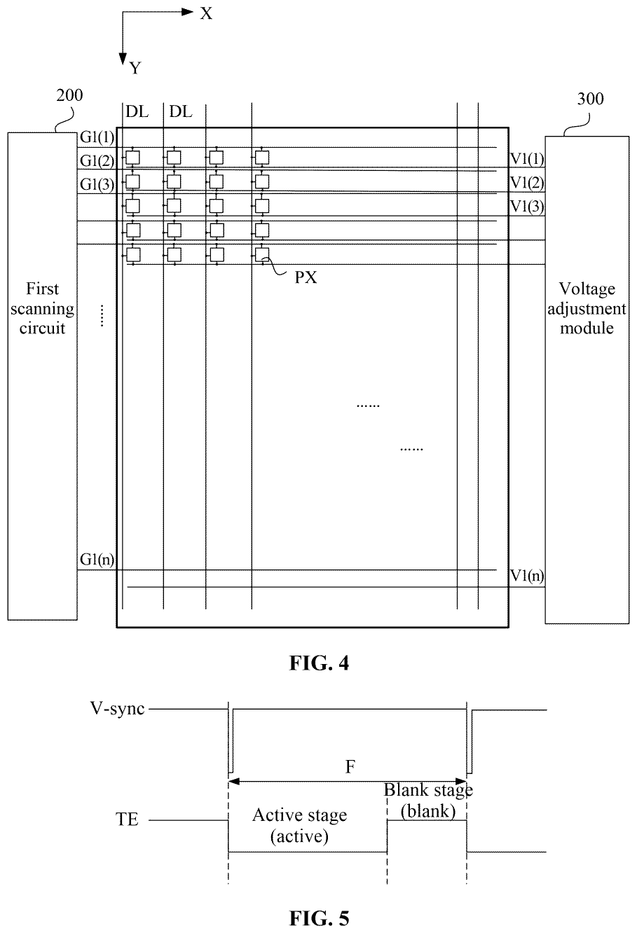

Embodiments of the present application provide a display device. FIG. 4 is a structural diagram of a display device according to an embodiment of the present application. The display device may be an electronic device such as a mobile phone, a computer or a tablet, or may be a display panel. Referring to FIG. 4, the display device includes a plurality of pixel circuits PX arranged in an array, a first scanning circuit 200 and a plurality of first scanning lines G1. The first scanning circuit 200 is electrically connected to a corresponding row of pixel circuits PX by a corresponding first scanning line G1. For example, a first first scanning line G1(1) is connected to a first row of pixel circuits PX, a second first scanning line G1(2) is connected to a second row of pixel circuits PX, . . . , and an n-th first scanning line G1(n) is connected to an n-th row of pixel circuits PX. The first scanning circuit 200 is configured to transmit a first scanning signal to the first scanning line G1.

A first voltage line V1 is electrically connected to the pixel circuit PX. The pixel circuit PX is configured to write a voltage on the first voltage line V1 to the pixel circuit PX in response to a pulse signal of the first scanning signal on the first scanning line G1. The number of first voltage lines V1 is at least one. An extension direction of the first voltage line V1 may be the same as an extension direction of the first scanning line G1, or may intersect the extension direction of the first scanning line G1. Here, the first voltage line V1 may be a power line, or may be an initialization signal line. In one embodiment, a plurality of first voltage lines V1 may exist. The plurality of first voltage lines V1 are electrically connected to each other and are electrically connected to the same voltage adjustment circuit 300, which is equivalent to first voltage lines V1(1) to V1(n) being electrically connected to each other with the same transmitted voltage. Different voltages are output to the first voltage line V1 in a first period and a second period in at least one image refresh period.

The first period and the second period are two different periods in an image refresh period. At at least part of occasions in the first period, pulse signals output to N first scanning lines G1 overlap each other, and at at least part of occasions in the second period, pulse signals output to M first scanning lines G1 overlap each other. The first scanning circuit 200 is configured to simultaneously output the pulse signals to the N first scanning lines G1 in the first period and is further configured to simultaneously output the pulse signals to the M first scanning lines G1 in the second period, where N and M are unequal positive integers. Therefore, in the first period and the second period, the in-plane load of the display device is different.

In one embodiment, the display device further includes a voltage adjustment circuit 300 electrically connected to the first voltage line V1 and configured to output the different voltages to the first voltage line V1 in the first period and the second period in the at least one image refresh period. In the present embodiment, when the in-plane load varies, the voltage output to the first voltage line V1 is adjusted to match with the in-plane load (a difference is between the load of the first scanning circuit 200 in the first period and the second period, and a difference is between the load of the first voltage line V1 in the first period and the second period), to improve non-uniform display or another problem of poor display. In one embodiment, N is greater than M, and an absolute value of a voltage output to the first voltage line V1 in the first period is greater than an absolute value of a voltage output to the first voltage line V1 in the second period.

In the embodiment of the present application, the different voltages are output to the first voltage line in the first period and the second period in the at least one image refresh period, and the pixel circuit writes the voltage on the first voltage line to the pixel circuit in response to the pulse signal of the first scanning signal on the first scanning line. Since the first voltage line writes the different voltages to the pixel circuits in the first period and the second period, undesirable phenomena such as non-uniform display caused by an in-plane load difference in the different periods in the display device can be improved, to contribute to improving a display effect.

The solution is described below in conjunction with embodiments.

FIG. 5 is a schematic diagram of a waveform of drive timing according to an embodiment of the present application. Referring to FIG. 5, in the present embodiment, an image refresh period F includes an active stage active and a blank stage blank. The image refresh period F may be limited by a vertical synchronization signal V-sync. The duration between a falling edge of the vertical synchronization signal V-sync and a falling edge of the next pulse is the time of one image refresh period F. The active stage active and the blank stage blank may be limited by an external interface signal TE of the display panel. The TE is a non-display trigger signal. In the TE, a duration of a high level may correspond to the blank stage blank, and a duration of a low level corresponds to the active stage active. At the active stage active, the pixel circuit PX can complete operations such as initialization, data writing and light emission. A vertical blanking interval, also referred to as a blank stage blank, exists between data written to the previous frame of image by the last row of pixel circuits PX and data written to the next frame of image by a first row of pixel circuits PX in a display region A.

FIG. 6 is a schematic diagram of a waveform of a voltage transmitted on a first voltage line according to an embodiment of the present application. Referring to FIGS. 5 and 6, in the image refresh period F, in a first period F1, the first voltage line V1 is configured to transmit a first sub-voltage VA1, and in a second period F2, the first voltage line V1 is configured to transmit a second sub-voltage VA2 different from the first sub-voltage VA1. The first period F1 is located within the active stage active, and the second period F2 is located within the blank stage blank.

With continued reference to FIG. 4, the display device further includes a plurality of data lines DL. The data line DL is configured to transmit a data voltage Vdata to implement the display of different grayscales of the display device. The data line DL extends along a Y direction, and the first scanning line G1 extends along an X direction. The X direction intersects the Y direction. The data line DL is electrically connected to a corresponding column of pixel circuits. The X direction may be a row direction, and the Y direction may be a column direction.

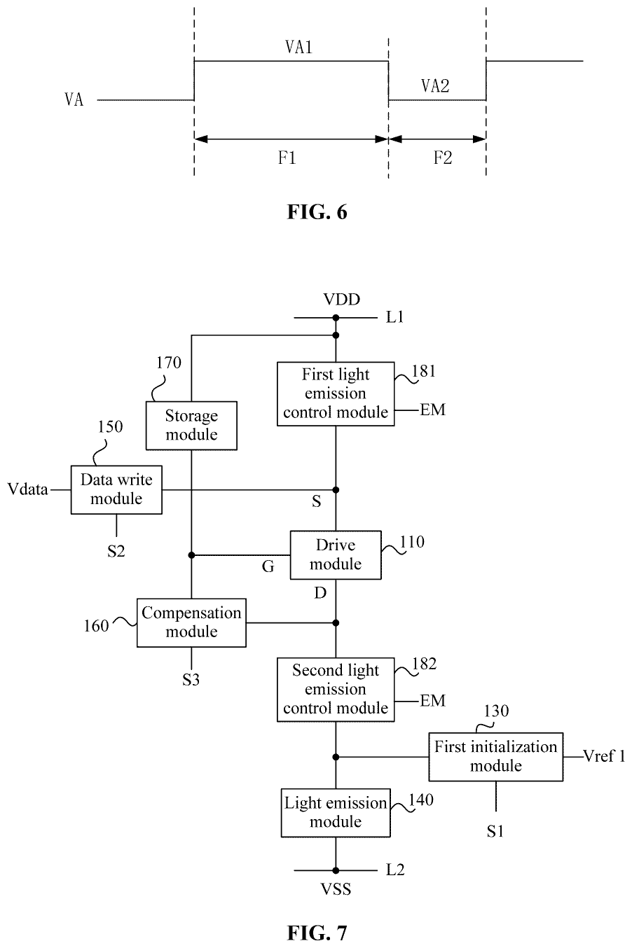

In one embodiment, the display device further includes a plurality of second scanning lines G2, where the second scanning line G2 is electrically connected to a corresponding row of pixel circuits, and the pixel circuit is configured to write the data voltage Vdata on the data line DL to the pixel circuit PX in response to a second scanning signal S2 on the second scanning line G2 at a data write stage. FIG. 7 is a structural diagram of a pixel circuit according to an embodiment of the present application. Referring to FIG. 7, on the basis of each of the above embodiments, the pixel circuit PX includes a drive circuit 110, a light emission circuit 140 and a first initialization circuit 130. The drive circuit 110 is connected between a first power line L1 and a first terminal of the light emission circuit 140, the first scanning circuit 200 is electrically connected to control terminals of first initialization circuits 130 in the corresponding row of pixel circuits PX by the corresponding first scanning lines G1, and the first initialization circuit 130 is connected between the first terminal of the light emission circuit 140 and a first initialization signal line R1 and is configured to transmit a first initialization voltage Vref1 on the first initialization signal line R1 to the first terminal of the light emission circuit 140 in response to the pulse signal of the first scanning signal S1 on the first scanning line G1.

In one embodiment, the display device further includes a plurality of light emission control signal lines U1, and the pixel circuit PX further includes a first light emission control circuit 181 and/or a second light emission control circuit 182, where the light emission control signal line U1 is separately connected to control terminals of first light emission control circuits 181 and control terminals of second light emission control circuits 182 in a corresponding row of pixel circuits PX, the first light emission control circuit 181 is connected between the first power line L1 and a first terminal S of the drive circuit 110, and the second light emission control circuit 182 is connected between a second terminal D of the drive circuit 110 and the first terminal of the light emission circuit 140.

In one embodiment, the pixel circuit PX further includes a data write circuit 150 and a compensation circuit 160.

The display device further includes a plurality of second scanning lines G2, where the second scanning line G2 is connected to control terminals of data write circuits 150 in a corresponding row of pixel circuits PX, and the data write circuit 150 is connected between the data line DL and the first terminal S of the drive circuit 110 and is configured to transmit the data voltage Vdata to the drive circuit 110 in response to a second scanning signal S2 on the second scanning line G2.

The display device further includes a plurality of third scanning lines G3, where the third scanning line G3 is connected to control terminals of compensation circuits 160 in a corresponding row of pixel circuits PX, and the compensation circuit 160 is connected between the second terminal D and a control terminal G of the drive circuit 110 and is configured to perform threshold compensation on the drive circuit 110 in response to a third scanning signal S3 on the third scanning line G3.

In one embodiment, the pixel circuit PX further includes a storage circuit 170 connected between the first power line L1 and the control terminal G of the drive circuit 110.

In the present embodiment, the first voltage line V1 may be the first initialization signal line R1, the voltage transmitted on the first voltage line V1 is the first initialization voltage Vref1, and the first initialization voltage Vref1 may be a negative voltage for resetting the first terminal of the light emission circuit 140.

The first power line L1 is configured to transmit a first power voltage VDD, and a second power line L2 is configured to transmit a second power voltage VSS. The first power voltage VDD may be greater than the second power voltage VSS. When a connection path between the first power line L1 and the second power line L2 is turned on, the drive circuit 110 drives the light emission circuit 140 to emit light. An operating process of the pixel circuit PX includes at least a first initialization stage, a data write stage and a light emission stage. At the first initialization stage, the first initialization circuit 130 is turned on in response to the first scanning signal S1 and transmits the first initialization voltage Vref1 to the first terminal of the light emission circuit 140 to initialize a potential of the first terminal of the light emission circuit 140. At the data write stage, the data write circuit 150 is turned on in response to the second scanning signal S2 and transmits the data voltage Vdata on the data line DL to the first terminal S of the drive circuit 110 and writes the data voltage Vdata to the control terminal G of the drive circuit 110 via the compensation circuit 160. At the light emission stage, the first light emission control circuit 181 and the second light emission control circuit 182 control the connection path between the first power line L1 and the second power line L2 to turn on and the drive circuit 110 can drive the light emission circuit 140 to emit light.

In one embodiment, in an image refresh period F, a first scanning signal S1 on the same first scanning line G1 includes a plurality of pulse signals. In conjunction with FIGS. 2 and 3, the first scanning signal S1 on the same first scanning line G1 including three pulse signals is used as an example. In the first period, each row of pixel circuits PX in the first region 11, the second region 12 and the third region 13 in the display region A correspond to the pulse signal of the first scanning signal S1. The first scanning circuit 200 simultaneously outputs the pulse signals to N first scanning lines G1 corresponding to the three regions. A corresponding row of pixel circuits PX transmit the first sub-voltage VA1 on the first voltage line V1 to the corresponding pixel circuits PX in response to the pulse signal of the first scanning signal S1. Here, each pulse signal in the first scanning signal S1 (the scanning signal SP) in FIGS. 2 and 3 may correspond to a plurality of first scanning lines G1, that is, a plurality of rows of pixel circuits PX may be scanned simultaneously.

At at least part of occasions in the first period, for example, a first occasion and a second occasion, the first scanning circuit 200 simultaneously outputs the pulse signals to the N first scanning lines G1. Since the scanning is performed progressively, for example, the scanning is performed from top to bottom, N first scanning lines G1 corresponding to the first occasion and N first scanning lines G1 corresponding to the second occasion are not exactly the same, for example, some of the first scanning lines G1 are different, or all of the first scanning lines G1 are different. For example, 100 first scanning lines G1 exist. Serial numbers of the N first scanning lines G1 at the first occasion are 1 to 10 (the first scanning circuit 200 outputs a third pulse signal to first scanning lines G1 whose serial numbers are 1 to 10), 41 to 50 (the first scanning circuit 200 outputs a second pulse signal to first scanning lines G1 whose serial numbers are 41 to 50) and 81 to 90 (the first scanning circuit 200 outputs a first pulse signal to first scanning lines G1 whose serial numbers are 81 to 90), and serial numbers of the N first scanning lines G1 at the second occasion are 2 to 11 (the first scanning circuit 200 outputs the third pulse signal to first scanning lines G1 whose serial numbers are 2 to 11), 42 to 51 (the first scanning circuit 200 outputs the second pulse signal to first scanning lines G1 whose serial numbers are 42 to 51) and 82 to 91 (the first scanning circuit 200 outputs the first pulse signal to first scanning lines G1 whose serial numbers are 82 to 91). The duration of each pulse signal is greater than an interval between starting occasions of pulse signals of two adjacent first scanning lines G1 (equivalent to a shift time interval between pulse signals output by shift registers at two adjacent stages in the first scanning circuit 200).

In the second period, at least one of the three pulse signals of the first scanning signal S1 of pixel circuits PX corresponding to some regions enters the blank stage blank. In this case, in the display region A, each row of pixel circuits PX in only two regions, the fourth region 21 and the fifth region 22, correspond to the pulse signal of the first scanning signal S1. The first scanning circuit 200 simultaneously outputs the pulse signals to M first scanning lines G1 in the two regions, where N may be greater than M.

At at least part of occasions in the second period, for example, a third occasion and a fourth occasion, the first scanning circuit 200 simultaneously outputs the pulse signals to the M first scanning lines G1. Since the scanning is performed progressively, for example, the scanning is performed from top to bottom, M first scanning lines G1 corresponding to the third occasion and M first scanning lines G1 corresponding to the fourth occasion are not exactly the same, for example, some of the first scanning lines G1 are different, or all of the first scanning lines G1 are different. For example, 100 first scanning lines G1 exist. Serial numbers of the M first scanning lines G1 at the third occasion are 31 to 40 (the first scanning circuit 200 outputs the third pulse signal to first scanning lines G1 whose serial numbers are 31 to 40) and 71 to 80 (the first scanning circuit 200 outputs the second pulse signal to first scanning lines G1 whose serial numbers are 71 to 80), and serial numbers of the M first scanning lines G1 at the fourth occasion are 32 to 41 (the first scanning circuit 200 outputs the third pulse signal to first scanning lines G1 whose serial numbers are 32 to 41) and 72 to 81 (the first scanning circuit 200 outputs the second pulse signal to first scanning lines G1 whose serial numbers are 72 to 81). Since the in-plane load varies, the voltage adjustment circuit 300 adjusts the first sub-voltage VA1 transmitted on the first voltage line V1 to the second sub-voltage VA2. A corresponding row of pixel circuits PX transmit the second sub-voltage VA2 on the first voltage line V1 to the corresponding pixel circuits PX in response to the pulse signal of the first scanning signal S1 to eliminate a split-screen phenomenon caused by a difference in the in-plane load in the different periods in the image refresh period F.

The second sub-voltage VA2 can be adjusted according to the first sub-voltage VA1. The voltage adjustment circuit 300 can determine a current compensation value according to a current refresh rate and/or a current display brightness value (DBV) of the display device and a correspondence between a refresh rate and/or a DBV and a compensation value and determine the second sub-voltage VA2 according to the current compensation value and the first sub-voltage VA1. For example, at a refresh rate of 120 Hz, the first sub-voltage VA1 is −0.5 V. When the pulse signal of the first scanning signal S1 succeeds in scanning the blank stage blank, a current compensation value at the current refresh rate is determined to be 0.5 V according to the correspondence between the refresh rate and/or the DBV and the compensation value. The second sub-voltage VA2 is determined to be −1.45 V according to the current compensation value and the first sub-voltage VA1, that is, the second sub-voltage VA2 is equal to a sum of the first sub-voltage VA1 and the current compensation value.

In another embodiment, the compensation value may also be characterized by a compensation coefficient. In this case, the second sub-voltage VA2 may also be equal to a product of the first sub-voltage VA1 and the current compensation value.

In the first period, the first initialization voltage Vref1 transmitted on the first initialization signal line R1 is the first sub-voltage VA1, and in the second period, the first initialization voltage Vref1 transmitted on the first initialization signal line R1 is the second sub-voltage VA2. Since the load in the second period decreases, the second sub-voltage VA2 increases, and both the first sub-voltage VA1 and the second sub-voltage VA2 are negative voltages and the absolute value of the first sub-voltage VA1 is greater than the absolute value of the second sub-voltage VA2.

In an actual application process, the correspondence between the refresh rate and/or the DBV and the compensation value can be stored in a driver chip in a form of three-dimensional table. When the display device displays, the driver chip can automatically detect the current refresh rate and/or the DBV and control, according to the correspondence, the voltage adjustment circuit 300 to dynamically adjust a voltage value of the first initialization voltage Vref1, to improve the display split-screen phenomenon. The DBV may also be referred to as a display brightness level. Display devices such as a mobile phone and a computer generally include a brightness adjustment key. A user varies an input display brightness level by using the brightness adjustment key. In the case of different DBVs, the same grayscale corresponds to different brightness. For example, the larger the DBV is, the larger the brightness corresponding to the maximum grayscale is.

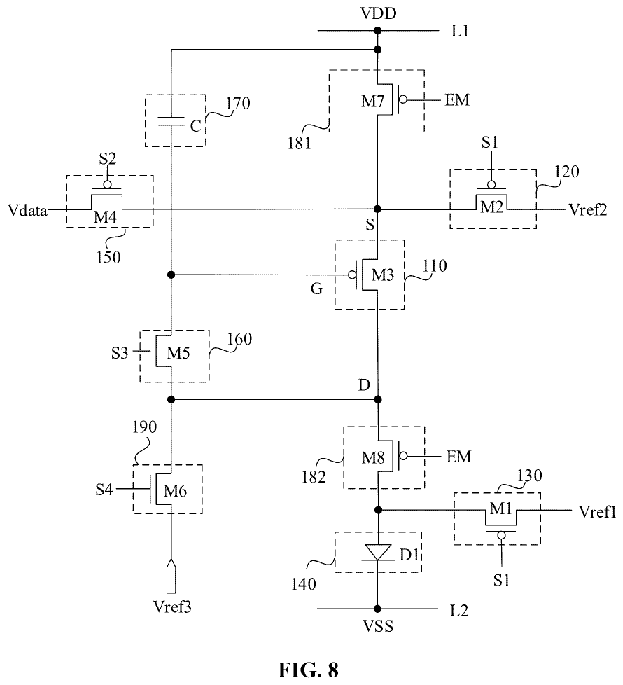

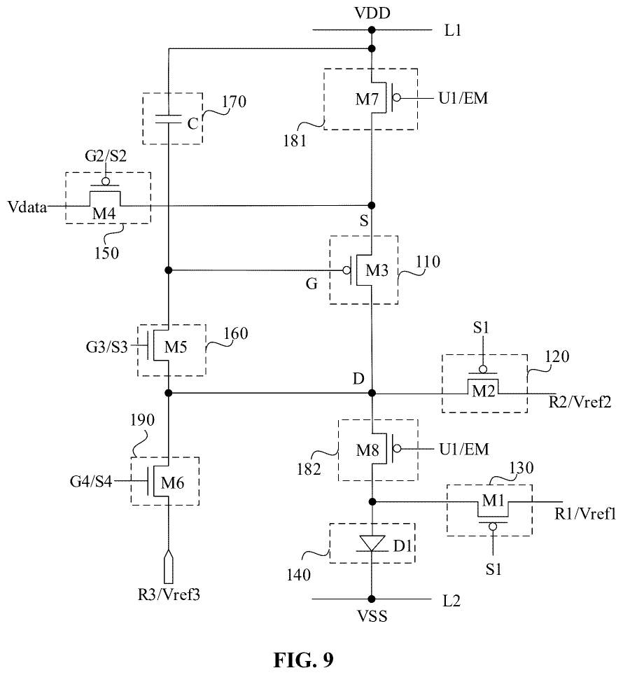

FIG. 8 is a structural diagram of another pixel circuit according to an embodiment of the present application. FIG. 9 is a structural diagram of another pixel circuit according to an embodiment of the present application. Referring to FIGS. 8 and 9, in one embodiment, the pixel circuit PX further includes a second initialization circuit 120, and the display device further includes a second initialization signal line R2. The second initialization circuit 120 is connected between the second initialization signal line R2 and the first terminal S or the second terminal D of the drive circuit 110, a control terminal of the second initialization circuit 120 is electrically connected to the first scanning line G1, and the second initialization circuit 120 is configured to transmit a second initialization voltage Vref2 on the second initialization signal line R2 to the first terminal S or the second terminal D of the drive circuit 110 in response to the pulse signal of the first scanning signal S1 on the first scanning line G1. At a second initialization stage, the second initialization circuit 120 is turned on in response to the first scanning signal S1 to reset the first terminal S or the second terminal D of the drive circuit 110.

In one embodiment, the pixel circuit PX further includes a third initialization circuit 190, and in one embodiment, the display device further includes a plurality of fourth scanning lines G4. The fourth scanning line G4 is connected to control terminals of third initialization circuits 190 in a corresponding row of pixel circuits PX.

In one embodiment, the display device further includes a third initialization signal line R3, where the third initialization circuit 190 is connected between the third initialization signal line R3 and the second terminal D of the drive circuit 110 and is configured to transmit a third initialization voltage Vref3 on the third initialization signal line R3 to the control terminal G of the drive circuit 110 via the compensation circuit 160 in response to a fourth scanning signal S4 on the fourth signal line G4. In one embodiment, the third initialization circuit 190 may also be directly electrically connected to the control terminal G of the drive circuit 110. The third initialization circuit 190 is connected between the third initialization signal line R3 and one terminal of the compensation circuit 160 connected to the control terminal G of the drive circuit 110. The third initialization circuit 190 is configured to directly transmit the third initialization voltage Vref3 on the third initialization signal line R3 to the control terminal G of the drive circuit 110 in response to the fourth scanning signal S4 on the fourth scanning line G4. At a third initialization stage, the third initialization circuit 190 is turned on in response to the fourth scanning signal S4 to reset the control terminal G of the drive circuit 110.

The first initialization circuit 130 includes a first transistor M1. A gate of the first transistor M1 is connected to the first scanning line G1, a first electrode of the first transistor M1 is connected to the first initialization signal line R1, and a second electrode of the first transistor M1 is connected to the first terminal of the light emission circuit 140. The first transistor M1 is configured to transmit the first initialization voltage Vref1 on the first initialization signal line R1 to the first terminal of the light emission circuit 140 at the first initialization stage.

In one embodiment, the second initialization circuit 120 includes a second transistor M2. A gate of the second transistor M2 is connected to the first scanning line G1, a first electrode of the second transistor M2 is connected to the second initialization signal line R2, and a second electrode of the second transistor M2 is connected to the first terminal S (as shown in FIG. 8) or the second terminal D (as shown in FIG. 9) of the drive circuit 110. The second transistor M2 is configured to transmit the second initialization voltage Vref2 on the second initialization signal line R2 to the first terminal S or the second terminal D of the drive circuit 110 at the second initialization stage.

In one embodiment, the drive circuit 110 includes a third transistor M3 (a drive transistor), the data write circuit 150 includes a fourth transistor M4, the compensation circuit 160 includes a fifth transistor M5, and the third initialization circuit 190 includes a sixth transistor M6. The first light emission control circuit 181 includes a seventh transistor M7, the second light emission control circuit 182 includes an eighth transistor M8, the light emission circuit 140 includes a light-emitting diode D1, and the storage circuit 170 includes a capacitor C. A gate of the fourth transistor M4 is connected to the second scanning line G2, a first electrode of the fourth transistor M4 is connected to the data line DL, and a second electrode of the fourth transistor M4 is connected to a first electrode of the third transistor M3. A gate of the fifth transistor M5 is connected to the third scanning line G3, a first electrode of the fifth transistor M5 is connected to a second electrode of the third transistor M3, and a second electrode of the fifth transistor M5 is connected to a gate of the third transistor M3. A gate of the sixth transistor M6 is connected to the fourth scanning line G4, a first electrode of the sixth transistor M6 is connected to the third initialization signal line, and a second electrode of the sixth transistor M6 is connected to the first electrode of the fifth transistor M5. Both a gate of the seventh transistor M7 and a gate of the eighth transistor M8 are connected to the light emission control signal lines U1. A first electrode of the seventh transistor M7 is connected to the first power line L1, and a second electrode of the seventh transistor M7 is connected to the first electrode of the third transistor M3. A first electrode of the eighth transistor M8 is connected to the second electrode of the third transistor M3, and a second electrode of the eighth transistor M8 is connected to a first electrode of the light-emitting diode D1. A second electrode of the light-emitting diode D1 is connected to the second power line L2. A first electrode of the capacitor C is connected to the first power line L1, and a second electrode of the capacitor C is connected to the gate of the third transistor M3. Here, in the light-emitting diode D1, the first electrode may be an anode, and the second electrode may be a cathode. The fifth transistor M5 and the sixth transistor M6 may be n-type transistors, or may be p-type transistors, and other transistors are all p-type transistors. In FIGS. 8 and 9, only the case where the fifth transistor M5 and the sixth transistor M6 are the n-type transistors is illustrated. For example, both the fifth transistor M5 and the sixth transistor M6 may be metal oxide transistors. An advantage of this setting is that the problem of electrical leakage of the gate of the third transistor M3 can be reduced, to contribute to maintaining the stability of a voltage of the gate of the third transistor M3.

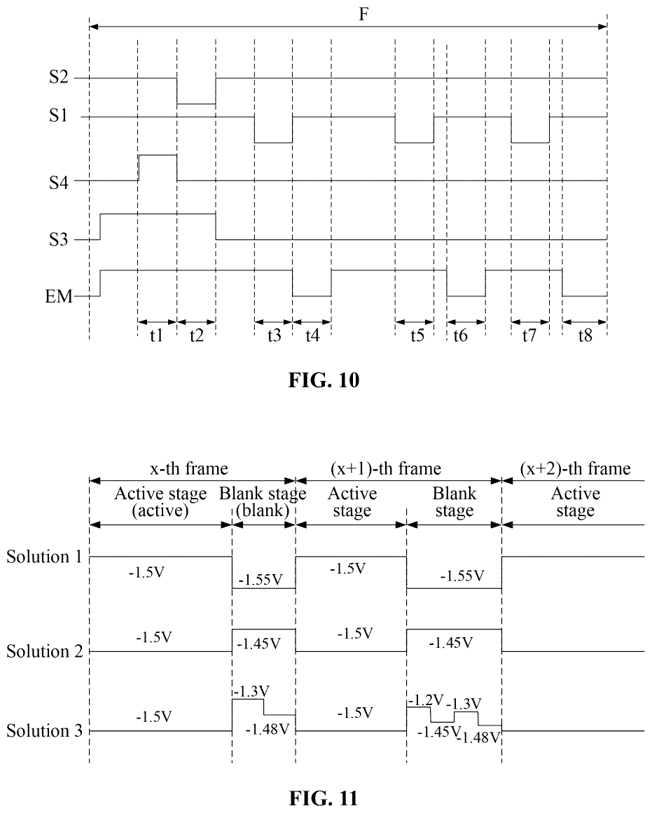

FIG. 10 is a drive timing graph of a pixel circuit according to an embodiment of the present application and may be applicable to the pixel circuits shown in FIGS. 8 and 9. In conjunction with FIGS. 8 to 10, An operating process of the pixel circuit provided in the present embodiment includes t1 to t8 stages.

At a t1 stage (corresponding to the third initialization stage), the first scanning signal S1 at an off level, for example, a logic high level, the second scanning signal S2 at an off level, for example, a logic high level, the third scanning signal S3 is at an on level, for example, a logic high level, the fourth scanning signal S4 is at an on level, for example, a logic high level, and a light emission control signal EM at an off level, for example, a logic high level. Therefore, the compensation circuit 160 and the third initialization circuit 190 are turned on, for example, the fifth transistor M5 and the sixth transistor M6 are turned on, and the third initialization voltage Vref3 on the third initialization signal line R3 is transmitted to the gate of the third transistor M3 via the sixth transistor M6 and the fifth transistor M5 to initialize the voltage of the gate of the third transistor M3. The third initialization voltage Vref3 is also transmitted to the second electrode D and the first electrode S of the third transistor M3 via the sixth transistor M6 to initialize the second electrode D and the first electrode S of the third transistor M3. The first initialization circuit 130, the second initialization circuit 120, the data write circuit 150, the first light emission control circuit 181 and the second light emission control circuit 182 are turned off.

At a t2 stage (corresponding to the data write stage), the first scanning signal S1 at an off level, for example, a logic high level, the second scanning signal S2 is at an on level, for example, a logic low level, the third scanning signal S3 is at an on level, for example, a logic high level, the fourth scanning signal S4 at an off level, for example, a logic low level, and the light emission control signal EM at an off level, for example, a logic high level. Therefore, the data write circuit 150 and the compensation circuit 160 are turned on, for example, the fourth transistor M4 and the fifth transistor M5 are turned on, the data voltage Vdata is written to the gate of the third transistor M3 via the fourth transistor M4, the third transistor M3 and the fifth transistor M5, and the voltage of the gate of the third transistor M3 is associated with the data voltage Vdata and a threshold voltage of the third transistor M3, thereby performing threshold compensation on the third transistor M3. The capacitor C stores the voltage of the gate of the third transistor M3. The first initialization circuit 130, the second initialization circuit 120, the third initialization circuit 190, the first light emission control circuit 181 and the second light emission control circuit 182 are turned off.

At a t3 stage (corresponding to the first initialization stage and the second initialization stage), the first scanning signal S1 at an off level, for example, a logic low level, the second scanning signal S2 at an off level, for example, a logic high level, the third scanning signal S3 at an off level, for example, a logic low level, the fourth scanning signal S4 at an off level, for example, a logic low level, and the light emission control signal EM at an off level, for example, a logic high level. Therefore, the first initialization circuit 130 and the second initialization circuit 120 are turned on, for example, the first transistor M1 and the second transistor M2 are turned on, and the first initialization voltage Vref1 on the first initialization signal line R1 is transmitted to the first electrode of the light-emitting diode D1 via the first transistor M1 to initialize the first electrode of the light-emitting diode D1. Moreover, the second initialization voltage Vref2 on the second initialization signal line R2 is transmitted to the first electrode of the third transistor M3 via the second transistor M2 to reset a voltage of the first electrode of the third transistor M3 to vary a bias state of the third transistor M3 and threshold characteristics of the third transistor M3 can remain stable at different grayscales to improve the uniformity of a drive current generated by the third transistor M3. The data write circuit 150, the compensation circuit 160, the third initialization circuit 190, the first light emission control circuit 181 and the second light emission control circuit 182 are turned off.

At a t4 stage (corresponding to the light emission stage), the first scanning signal S1 at an off level, for example, a logic high level, the second scanning signal S2 at an off level, for example, a logic high level, the third scanning signal S3 at an off level, for example, a logic low level, the fourth scanning signal S4 at an off level, for example, a logic low level, and the light emission control signal EM is at an on level, for example, a logic low level. Therefore, the first light emission control circuit 181 and the second light emission control circuit 182 are turned on, for example, the seventh transistor M7 and the eighth transistor M8 are turned on, the connection path between the first power line L1 and the second power line L2 is turned on, and the third transistor M3 generates the drive current to drive the light-emitting diode D1 to emit light. The data write circuit 150, the compensation circuit 160, the first initialization circuit 130, the second initialization circuit 120 and the third initialization circuit 190 are turned off.

Operating states of the elements at a t5 stage and a t7 stage are the same as the working states of the elements at the t3 stage.

Working states of the elements at a t6 stage and a t8 stage are the same as the working states of the elements at the t4 stage.

The drive timing shown in FIG. 10 is the drive timing in an image refresh period F. In the image refresh period F, the third initialization stage and the data write stage are performed on a plurality of rows of pixel circuits PX in sequence. For the first scanning signal S1, in the image refresh period F, three pulse signals exist. In the first period, pixel circuits in three regions in the plane (the display region A shown in FIG. 2) are in a scan refresh state. As the scanning time continues, in the second period, the pulse signal of the first scanning signal S1 originally corresponding to the third region 13 moves down stage by stage and just succeeds in scanning the blank stage blank and the number of first scanning lines G1 simultaneously driven in the plane reduces, and correspondingly, the in-plane load reduces. The voltage adjustment circuit 300 adjusts the first sub-voltage VA1 on the first initialization signal line R1 to the second sub-voltage VA2 according to the current refresh rate and/or the current DBV to reduce an initialization degree of the anode of the light-emitting diode D1 in the second period, to improve display uniformity.

FIG. 11 is a schematic diagram illustrating a voltage variation of a first initialization signal line according to an embodiment of the present application. For example, a refresh rate of 120 Hz is used as an example. In a solution 1, a voltage variation on a first initialization signal line R1 in the related art is described. A constant voltage source circuit outputs the same direct current potential to the first initialization signal line R1 in both a first period and a second period. For example, the constant voltage source circuit outputs the same direct current potential to the first initialization signal line R1 at both an active stage active and a blank stage blank. At the active stage active, a first initialization voltage Vref1 transmitted on the first initialization signal line R1 is −0.5 V. When pulse signals of a first scanning signal S1 corresponding to pixel circuits PX in some regions succeed in scanning the blank stage blank, the first initialization voltage Vref1 transmitted on the first initialization signal line R1 hops to −1.55 V due to the reduction of the load and the effects of the load and the line voltage drop. The first initialization voltage Vref1 is pulled down and an initialization degree of an anode of a light-emitting diode D1 is more sufficient.

In a solution 2, the voltage variation on the first initialization signal line R1 provided in the present embodiment is described. When the pulse signal of the first scanning signal S1 enters the blank stage blank, that is, in the second period, the voltage adjustment circuit 300 adjusts the first initialization voltage Vref1 from −1.5 V to −1.45 V (that is, adjusted from the first sub-voltage VA1 to the second sub-voltage VA2) to reduce the initialization degree of the anode of the light-emitting diode D1. The second sub-voltage VA2 is a constant value.

In one embodiment, the voltage adjustment circuit 300 is configured to output a constant voltage to the first voltage line V1 at the active stage active, and the voltage adjustment circuit 300 is used for outputting a constant voltage to the first voltage line V1 at the blank stage blank or outputting a variable voltage that stepwise varies with time to the first voltage line V1 at the blank stage blank.

Of course, in another optional embodiment provided in the present embodiment, the second sub-voltage VA2 may also be a voltage that stepwise varies with time, for example, as shown in a solution 3. The second sub-voltage VA2 includes a plurality of pulse signals with unequal amplitudes. The second sub-voltage VA2 is adjusted in a voltage adjustment manner of pulse-width modulation (PWM). This contributes to improving the voltage accuracy of the second sub-voltage VA2 and facilitates improving the display effect.

In an image refresh period, the number of pulses of the second sub-voltage VA2 is related to the current refresh rate. If the current refresh rate is a first preset refresh rate, the number of pulses of the second sub-voltage VA2 in the image refresh period is P, or if the current refresh rate is a second preset refresh rate, the number of pulses of the second sub-voltage VA2 in the image refresh period is Q, where the first preset refresh rate is greater than the second preset refresh rate, P<Q, and both P and Q are integers greater than or equal to 1.

With continued reference to FIG. 11, an X-th frame and an (X+1)-th frame are two image refresh periods. A refresh rate of the (X+1)-th frame is less than a refresh rate of the X-th frame. Since the refresh rate of the (X+1)-th frame is relatively small, the duration of a blank stage blank corresponding to the (X+1)-th frame is relatively long and more pulse signals can be set to further improve the voltage accuracy. In one embodiment, when the current refresh rate is 120 Hz, the number of pulses of the second sub-voltage VA2 may be K, for example, two, as shown in the x-th frame in FIG. 11. When the current refresh rate is 90 Hz, the number of pulses of the second sub-voltage VA 2 may be 2K, for example, four, as shown in the (x+1)-th frame in FIG. 11. When the current refresh rate is 60 Hz, the number of pulses of the second sub-voltage VA2 may be 3K, for example, six, and so on. K may be a positive integer.

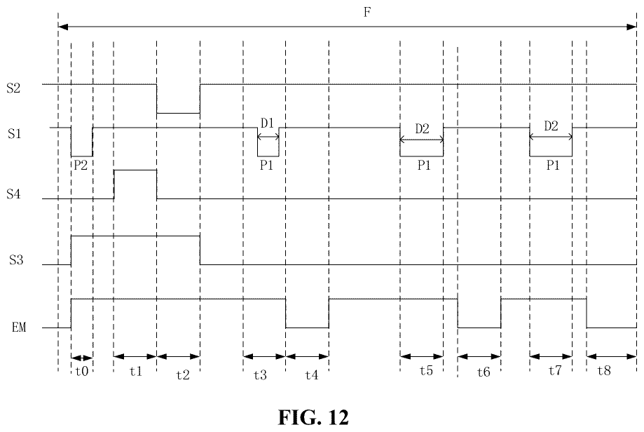

FIG. 12 is a drive timing graph of another pixel circuit according to an embodiment of the present application. Referring to FIG. 12, in one embodiment, in an image refresh period, the first scanning signal S1 on the same first scanning line G1 includes a plurality of first pulse signals P1 after data write stages of pixel circuits PX electrically connected to the same first scanning line G1.

In one embodiment, at at least part of occasions in the first period, the first pulse signals P1 output to the N first scanning lines G1 overlap each other, and at at least part of occasions in the second period, the first pulse signals P1 output to the M first scanning lines G1 overlap each other, which is equivalent to the first scanning circuit 200 being configured to simultaneously output the first pulse signals P1 to the N first scanning lines G1 in the first period and simultaneously output the first pulse signals P1 to the M first scanning lines G1 in the second period.

In one embodiment, the first period is before the second period.

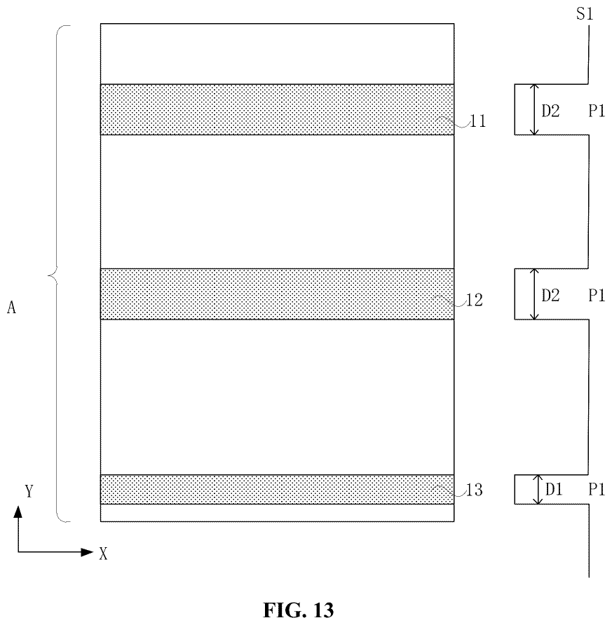

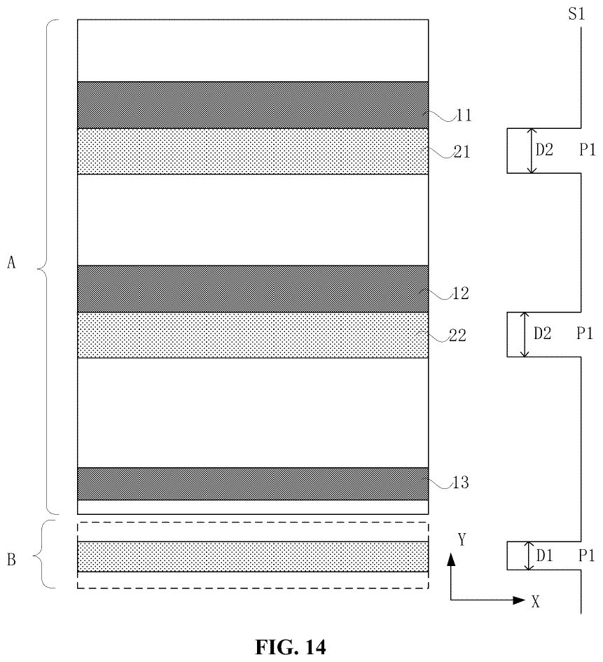

FIG. 13 is a schematic diagram illustrating a display result of a display panel according to an embodiment of the present application in a first period. FIG. 14 is a schematic diagram illustrating a display result of a display panel according to an embodiment of the present application in a second period. In conjunction with FIGS. 12 to 14, in one embodiment, in the image refresh period, a width D1 of a first first pulse signal P1 of the first scanning signal S1 on the same first scanning line G1 is less than or equal to a width D2 of each of the remaining first pulse signals P1, and the width D1 of the first first pulse signal P1 is less than a width D2 of at least one of the remaining first pulse signals P1. The larger the width of the first pulse signal P1 is, the larger the number of rows of the turned-on pixel circuits PX corresponding to the first pulse signal P1 is, which is equivalent to the larger the sizes of the first region 11, the second region 12 and the third region 13 along the column direction Y. This setting can reduce the load difference of the first voltage line V1 between the first period and the second period (if three first pulse signals P1 exist, and widths of all of the first pulse signals P1 are equal, a load difference value of the first voltage line V1 between the first period and the second period is ⅓ of the load of the first voltage line V1 in the first period, and if the width D1 of the first first pulse signal P1 is less than or equal to the width D2 of the each of the remaining first pulse signals P1 and widths D2 of the remaining first pulse signals P1 are equal, the load difference value of the first voltage line V1 between the first period and the second period is less than ⅓ of the load of the first voltage line V1 in the first period), to contribute to improving the split-screen phenomenon and/or better controlling the reset time of the anode of the light-emitting diode D1 and better matching with the actual duration of the blank stage blank.

In one embodiment, in the image refresh period, the first pulse signals P1 on the same first scanning line G1 may be located within the write frame. In the image refresh period, a plurality of first pulse signals P1 may be in the write frame, for example, two or three. For example, in the image refresh period, two first pulse signals P1 may exist on the same first scanning line G1. Therefore, the problem of two split screens can be improved in the present application. For example, in the image refresh period, three first pulse signals P1 may exist on the same first scanning line G1. Therefore, the problem of three split screens can be improved in the present application.

With continued reference to FIG. 12, in one embodiment, in the image refresh period, the first scanning signal S1 on the same first scanning line G1 further includes second pulse signals P2 of the pixel circuits PX at t0 stages (equivalent to initialization stages) before the data write stages (t2 stages), and the pixel circuits PX electrically connected to the same first scanning line G1. The second pulse signal P2 can be used for preparing for the reset of the anode of the light-emitting diode D1 and/or the reset of a gate of the drive transistor and the reset of a source or a drain. At the t0 stage, the first initialization circuit 130, the second initialization circuit 120 and the compensation circuit 160 are turned on to reset the control terminal G of the drive circuit 110 and the first terminal of the light emission circuit 140 and reset the first terminal S or the second terminal D of the drive circuit 110. The data write circuit 150, the third initialization circuit 190, the first light emission control circuit 181 and the second light emission control circuit 182 are turned off.

In conjunction with FIG. 5, in one embodiment, the first scanning circuit 200 includes a plurality of cascaded shift registers. Within the low level of the TE signal, the plurality of stages of shift registers of the first scanning circuit 200 output the pulse signals of the first scanning signal S1 stage by stage. The first period is before a shift register at the last stage of the first scanning circuit 200 outputs the first first pulse signal P1 to a first scanning line G1 electrically connected to the shift register at the last stage, and the second period is after the shift register at the last stage of the first scanning circuit 200 outputs the first first pulse signal P1 to the first scanning line G1 electrically connected to the shift register at the last stage.

In one embodiment, a time interval between two adjacent first pulse signals P1 on the same first scanning line G1 is less than a time interval between a shift register at a first stage in the first scanning circuit 200 outputs the first first pulse signal P1 and the shift register at the last stage outputs the first first pulse signal P1. The width of the first pulse signal P1 may be greater than a shift time interval between first pulse signals P1 output by shift registers at two adjacent stages. Therefore, the larger the width of the first pulse signal P1 is, the larger the number of shift registers simultaneously outputting the first first pulse signal P1 is, and the larger the number of rows of the turned-on pixel circuits PX corresponding to the first first pulse signal P1 is. Similarly, it may be known that the number of rows of turned-on pixel circuits PX corresponding to another first pulse signal P1.

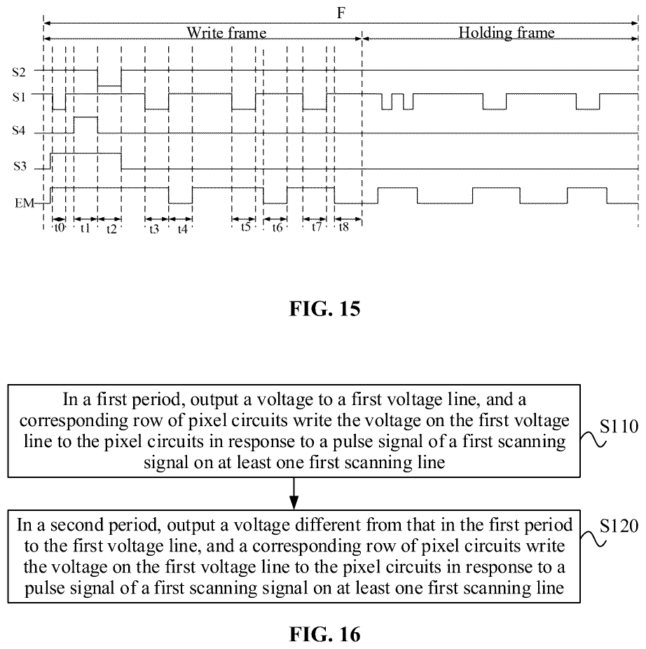

In the present embodiment, in the case where the refresh rate is switched, the rate is generally reduced through a frame insertion method on the basis of a basic rate. An image refresh period of the basic rate includes a write frame, where the active stage active is located within the write frame, and at least a portion of the blank stage blank is located within the write frame. For example, when the refresh rate is 120 Hz, only the write frame exists, and no holding frame exists. An image refresh period of a reduced refresh rate (for example, less than 120 Hz) includes a write frame and a holding frame, where the active stage active is located within the write frame, a portion of the blank stage blank is located within the write frame, and the holding frame is located within the blank stage blank. In the holding frame, a data write operation may not be performed, that is, no data write stage exists. FIG. 15 is a drive timing graph of another pixel circuit according to an embodiment of the present application. Referring to FIG. 15, in the holding frame, the first scanning signal S1 still outputs the pulse signal to reset the anode of the light-emitting diode D1.

In the present embodiment, frequencies of the second scanning signal S2, the third scanning signal S3 and the fourth scanning signal S4 are all equal to the refresh rate, and a frequency of the first scanning signal S1 is greater than the refresh rate. For example, the refresh rate is 120 Hz, and the frequency of the first scanning signal S1 may be 360 Hz. The frequency of the first scanning signal S1 is set to be greater than the refresh rate and the first electrode (the anode) of the light-emitting diode D1 can be initialized in both the write frame and the holding frame to improve the display effect.

Embodiments of the present application further provide a driving method of a display device. The driving method of a display device can be used for driving the display device provided in any one of the preceding embodiments. FIG. 16 is a flowchart of a driving method of a display device according to an embodiment of the present application. Referring to FIG. 16, the driving method includes the steps described below.

In S110, in a first period, a voltage is output to a first voltage line, and a corresponding row of pixel circuits write the voltage on the first voltage line to the pixel circuits in response to a pulse signal of a first scanning signal on at least one first scanning line.

In S120, in a second period, a voltage different from that in the first period is output to the first voltage line, and a corresponding row of pixel circuits write the voltage on the first voltage line to the pixel circuits in response to a pulse signal of a first scanning signal on at least one first scanning line.

In the embodiment of the present application, the different voltages are output to the first voltage line in the first period and the second period in at least one image refresh period, and the pixel circuit writes the voltage on the first voltage line to the pixel circuit in response to the pulse signal of the first scanning signal on the first scanning line. Since the first voltage line writes the different voltages to the pixel circuits in the first period and the second period, undesirable phenomena such as non-uniform display caused by an in-plane load difference in the different periods in the display device can be improved, to contribute to improving a display effect.

In one embodiment, the first voltage line is a first initialization signal line R1 and is configured to provide a first initialization voltage to a light emission circuit. The first period is located within an active stage of an image refresh period, and the second period is located within a blank stage blank.

The step S110 includes: in the first period, a voltage adjustment circuit outputs a first sub-voltage to the first voltage line, and a corresponding row of pixel circuits write the voltage on the first voltage line to the pixel circuits in response to a pulse signal of a first scanning signal on at least one first scanning line.

The step S120 includes: in the second period, the voltage adjustment circuit determines a current compensation value according to a current refresh rate and/or a current DBV of the display device and a correspondence between a refresh rate and/or a DBV and a compensation value, determines a second sub-voltage according to the current compensation value and the first sub-voltage, outputs the second sub-voltage to the first voltage line and controls a corresponding row of pixel circuits to write the voltage on the first voltage line to the pixel circuits in response to a pulse signal of a first scanning signal on at least one first scanning line.

The driving method provided in the embodiment of the present application may be applicable to the display device provided in any one of the preceding embodiments. Therefore, the driving method also has the effects described in any one of the preceding embodiments.

In one embodiment, at some or all occasions in the first period, pulse signals output to N first scanning lines overlap each other. In one embodiment, in the first period, a first scanning circuit simultaneously outputs the pulse signals to the N first scanning lines.

In one embodiment, at some or all occasions in the second period, pulse signals output to M first scanning lines overlap each other, where N and M are unequal positive integers. In one embodiment, in the second period, the first scanning circuit simultaneously outputs the pulse signals to the M first scanning lines, where N and M are unequal positive integers.

The preceding embodiments do not limit the scope of the present disclosure. Various modifications, combinations, sub-combinations, and substitutions may be performed according to design requirements and other factors. Any modification, equivalent substitution, improvement or the like made within the spirit and principle of the present disclosure is within the scope of the present disclosure.

What is claimed is:

1. A display device, comprising:
a plurality of pixel circuits arranged in an array;
a first scanning circuit and a plurality of first scanning lines, wherein the first scanning circuit is electrically connected to the plurality of pixel circuits by the plurality of first scanning lines; and
a first voltage line electrically connected to the plurality of pixel circuits, wherein each pixel circuit of the plurality of pixel circuits is configured to write a voltage on the first voltage line to the each pixel circuit in response to a pulse signal of a first scanning signal on the first scanning line; and
different voltages are output to the first voltage line in a first period and a second period in at least one image refresh period.

2. The display device according to claim 1, further comprising: a voltage adjustment circuit, wherein
the voltage adjustment circuit is electrically connected to the first voltage line and is configured to output the different voltages to the first voltage line in the first period and the second period in the at least one image refresh period.

3. The display device according to claim 1, wherein an image refresh period comprises an active stage and a blank stage, the first period is located within the active stage, and the second period is located within the blank stage.

4. The display device according to claim 3, further comprising: a voltage adjustment circuit electrically connected to the first voltage line, wherein
the voltage adjustment circuit is configured to output the different voltages to the first voltage line in the first period and the second period in the at least one image refresh period; and
the voltage adjustment circuit is further configured to output a constant voltage to the first voltage line at the active stage, and
the voltage adjustment circuit is further configured to output a constant voltage to the first voltage line at the blank stage or output a variable voltage to the first voltage line at the blank stage;
wherein the variable voltage varies stepwise with time.

5. The display device according to claim 3, wherein the image refresh period comprises a write frame, wherein the active stage is within the write frame, and at least a portion of the blank stage is located within the write frame.

6. The display device according to claim 5, wherein the image refresh period further comprises a holding frame, and the holding frame is located within the blank stage.

7. The display device according to claim 1, wherein at at least part of occasions in the first period, pulse signals output by the first scanning circuit to N first scanning lines of the plurality of first scanning lines overlap each other, and at at least part of occasions in the second period, pulse signals output by the first scanning circuit to M first scanning lines of the plurality of first scanning lines overlap each other;
wherein N and M are unequal positive integers, N is greater than M, and an absolute value of a voltage output to the first voltage line in the first period is greater than an absolute value of a voltage output to the first voltage line in the second period.

8. The display device according to claim 1, wherein in an image refresh period, a first scanning signal on a same first scanning line comprises a plurality of pulse signals.

9. The display device according to claim 8, further comprising: a plurality of data lines and a plurality of second scanning lines, wherein the plurality of data lines are electrically connected to the plurality of pixel circuits, the plurality of second scanning lines are electrically connected to the plurality of pixel circuits, and each pixel circuit of the plurality of pixel circuits is further configured to write a data voltage on a data line to the each pixel circuit in response to a second scanning signal on a second scanning line at a data write stage;
in the image refresh period, the first scanning signal on the same first scanning line comprises a plurality of first pulse signals after the data write stage corresponding to pixel circuits electrically connected to the same first scanning line; at at least part of occasions in the first period, the first pulse signals output by the first scanning circuit to the N first scanning lines of the plurality of first scanning lines overlap each other, and at at least part of occasions in the second period, the first pulse signals output by the first scanning circuit to the M first scanning lines of the plurality of first scanning lines overlap each other; and
wherein N and M are unequal positive integers, N is greater than M, and the first period is before the second period.

10. The display device according to claim 9, wherein in the image refresh period, a width of a first first pulse signal of the first scanning signal on the same first scanning line is less than or equal to a width of each of the remaining first pulse signals of the plurality of first pulse signals.

11. The display device according to claim 9, wherein the first scanning circuit comprises a plurality of cascaded shift registers, wherein the first period is before an occasion when a shift register at a last stage of the first scanning circuit outputs a first first pulse signal to a first scanning line of the plurality of first scanning lines electrically connected to the shift register at the last stage of the first scanning circuit, and the second period is after an occasion when the shift register at the last stage of the first scanning circuit outputs the first first pulse signal to the first scanning line electrically connected to the shift register at the last stage of the first scanning circuit; and
in the image refresh period, the first scanning signal on the same first scanning line comprises a second pulse signal before the data write stage corresponding to the pixel circuits electrically connected to the same first scanning line.

12. The display device according to claim 1, wherein a voltage output to the first voltage line in the first period is a first sub-voltage, and a voltage output to the first voltage line in the second period is a second sub-voltage; and
the display device further comprises: a voltage adjustment circuit, wherein the voltage adjustment circuit is configured to determine a current compensation value according to at least one of a current refresh rate and a current display brightness value (DBV) of the display device and a correspondence between a compensation value and at least one of a refresh rate and a DBV, and determine the second sub-voltage according to the current compensation value and the first sub-voltage.

13. The display device according to claim 12, wherein the second sub-voltage is equal to a sum of the first sub-voltage and the current compensation value.

14. The display device according to claim 12, wherein an absolute value of the first sub-voltage is greater than an absolute value of the second sub-voltage; and
the first sub-voltage and the second sub-voltage are negative voltages.

15. The display device according to claim 1, wherein a voltage output to the first voltage line in the first period is a first sub-voltage, a voltage output to the first voltage line in the second period is a second sub-voltage, and the second sub-voltage comprises a plurality of pulse signals with unequal amplitudes.

16. The display device according to claim 15, wherein when a current refresh rate is a first preset refresh rate, a number of pulses of the second sub-voltage is P;
when a current refresh rate is a second preset refresh rate, a number of pulses of the second sub-voltage is Q;
wherein the first preset refresh rate is greater than the second preset refresh rate, P<Q, and both P and Q are integers greater than or equal to 1.

17. The display device according to claim 1, wherein the first voltage line is a first initialization signal line; and
each of the plurality of pixel circuits comprises a drive circuit, a light emission circuit and a first initialization circuit; wherein
the drive circuit is connected between a first power line and a first terminal of the light emission circuit, the first scanning circuit is electrically connected to control terminals of first initialization circuits of the plurality of pixel circuits by the plurality of first scanning lines, and the first initialization circuit is connected between the first terminal of the light emission circuit and the first initialization signal line and is configured to transmit a first initialization voltage on the first initialization signal line to the first terminal of the light emission circuit in response to a pulse signal of a first scanning signal on the first scanning line.

18. The display device according to claim 17, wherein each of the plurality of pixel circuits further comprises a second initialization circuit;
the display device further comprises a second initialization signal line, wherein the second initialization circuit is connected between the second initialization signal line and a first terminal or a second terminal of the drive circuit, a control terminal of the second initialization circuit is electrically connected to the first scanning line, and the second initialization circuit is configured to transmit a second initialization voltage on the second initialization signal line to the first terminal or the second terminal of the drive circuit in response to a pulse signal of a first scanning signal on the first scanning line;
each of the plurality of pixel circuits further comprises: a first light emission control circuit and a second light emission control circuit;
the display device further comprises a plurality of light emission control signal lines, wherein the plurality of light emission control signal lines are connected to control terminals of first light emission control circuits and control terminals of second light emission control circuits in the plurality of pixel circuits, the first light emission control circuit is connected between the first power line and the first terminal of the drive circuit, and the second light emission control circuit is connected between the second terminal of the drive circuit and the first terminal of the light emission circuit;
each of the plurality of pixel circuits further comprises a data write circuit, a compensation circuit, a third initialization circuit and a storage circuit;
the display device further comprises:
a plurality of second scanning lines, wherein the plurality of second scanning lines are connected to control terminals of data write circuits in the plurality of pixel circuits;
a data line, wherein the data write circuit is connected between the data line and the first terminal of the drive circuit and is configured to transmit a data voltage to the drive circuit in response to a second scanning signal on the second scanning line;
a plurality of third scanning lines, wherein the plurality of third scanning lines are connected to control terminals of compensation circuits in the plurality of pixel circuits, and the compensation circuit is connected between the second terminal and a control terminal of the drive circuit;
a plurality of fourth scanning lines, wherein the plurality of fourth scanning lines are connected to control terminals of third initialization circuits in the plurality of pixel circuits;
a third initialization signal line, wherein the third initialization circuit is connected between the third initialization signal line and the second terminal of the drive circuit and is configured to transmit a third initialization voltage on the third initialization signal line to a control terminal of the drive circuit via the compensation circuit in response to a fourth scanning signal on the fourth scanning line; and
the storage circuit is connected between the first power line and the control terminal of the drive circuit.

19. A driving method of a display device,
wherein the display device comprises a plurality of pixel circuits arranged in an array, a first scanning circuit, a plurality of first scanning lines and a first voltage line;
wherein the first scanning circuit is electrically connected to the plurality of pixel circuits by the plurality of first scanning lines, and the first voltage line is electrically connected to the plurality of pixel circuits;
wherein the driving method comprises: in a first period, outputting a voltage to the first voltage line, writing the voltage on the first voltage line to at least one row of pixel circuits in response to a pulse signal of a first scanning signal on at least one first scanning line of the plurality of first scan lines,
in a second period, outputting a voltage different from that in the first period to the first voltage line, writing the voltage on the first voltage line to at least one row of pixel circuits in response to a pulse signal of a first scanning signal on at least one first scanning line of the plurality of first scanning lines.

20. The driving method of a display device according to claim 19, wherein at at least part of occasions in the first period, pulse signals output to N first scanning lines of the plurality of first scanning lines overlap each other; and
at at least part of occasions in the second period, pulse signals output to M first scanning lines of the plurality of first scanning lines overlap each other, wherein N and M are unequal positive integers.
